(19) United States
(12) Patent Application Publication
(10) Pub. No.: US 2021/0336987 A1
(43) Pub. Date: Oct. 28, 2021

(54) Method for Detecting Structured Query Language (SQL) Injection Based on Big Data Algorithm

(71) Applicants: Bluedon Information Security Technologies Corp., Guangzhou (CN); Bluedon Information Security Technologies Co., Ltd., Guangzhou (CN)

(72) Inventors: Zonggui Ke, Guangzhou (CN); Baoming Zhang, Guangzhou (CN); Xiaoning Qin, Guangzhou (CN)

(21) Appl. No.: 16/858,697

(22) Filed: Apr. 26, 2020

(51) Int. Cl. H04L 29/06; G06N 20/00

(52) U.S. Cl. CPC H04L 63/1466; G06N 20/00; H04L 63/1416

(57) ABSTRACT

The present invention discloses a method for detecting Structured Query Language (SQL) injection based on a big data algorithm. According to the method, by simulating an attack, extracting a great number of SQL injection statements, performing a series of word segmentation and URL character conversion, and performing cross verification and learning, a training set of a naive Bayes algorithm is constructed; network audit data is processed by characteristic engineering and then substituted into the algorithm, so that a result for detecting the SQL injection is obtained; and furthermore, a business expert may make a further confirmation on the result to store the statement, which is confirmed as the SQL injection, to the training set again, so that the training set is increasingly rich, the identification accuracy is gradually increased, and the false alarm rate and the alarm leakage rate are gradually decreased.

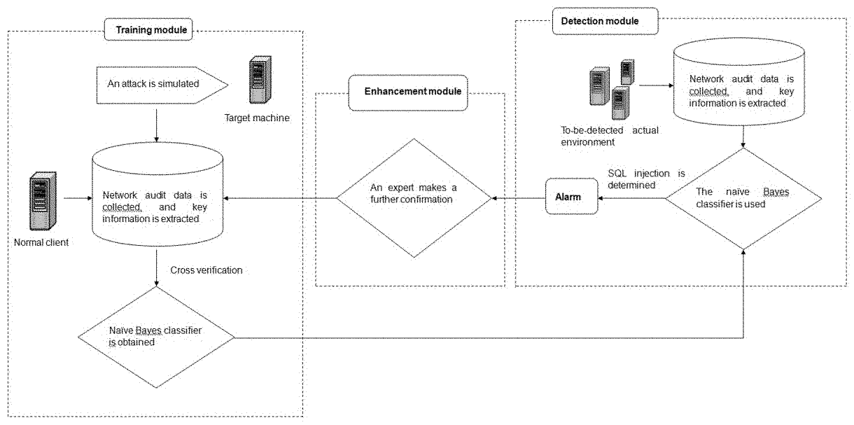

### TECHNICAL FIELD

The present invention relates to the technical field of data processing, and in particular to a method for detecting Structured Query Language (SQL) injection based on a big data algorithm.

### BACKGROUND

Structured Query Language (SQL) injection is to insert an SQL command into an address field or a character string requested by a page, with an aim to query information in a server database and steal relevant information illegally. An attacker of the SQL injection often uses a security loophole on a website to steal confidential information of a backend database, but not execute an SQL statement according to an intention of a designer.

At present, most of websites do not provide security protection for the database, backends of a majority of websites use administrator rights to connect the database, and the confidential information is directly stored in the database in a plaintext. As a consequence, some crackers use this loophole to steal relevant information of the database and they often steal an account password of a user, obtain the right of the administrator, etc., so that a large amount of data is leaked. There is never an absolutely secure backend in the world. Hence, while the backend protection is provided, it is crucial to discover an attack source of the SQL injection timely, thus solving the problem in time from the source.

An existing SQL injection identification method tends to enumerate, based on a rule, a keyword and some special symbols in an SQL grammar to match a Universal Resource Locator (URL) in a webpage. Such a method is quick, convenient and effective. However, each website is different and a transfer parameter is also complex and changeable, so such a rule matching manner is prone to cause a false alarm or an alarm failure.

### SUMMARY

First of all, an operation and maintenance engineer strikes a large number of SQL injection attacks of different categories into a target machine; and upon confirmation of an expert, the SQL injection attacks serve as training data, and a Spark distributed cluster is used to train a naive Bayes classifier model regularly. Then, by means of deploying a special protocol analysis tool in a network node, a data message is unpacked one by one from a data link layer, a network layer and a transmission layer; Internet Protocol (IP) address information, an access path, a request parameter and other characteristics in a head of a protocol are analyzed; audit information of each network behavior is obtained; a sample is obtained by means of data sampling; a naive Bayes model and other models are input for detection; then, a result of a classifier is stored to a hdfs of a distributive storage system Hadoop; and when an output result of the classifier is abnormal, an alarm is given.

In order to achieve the above objective, the technical solutions of a method for detecting SQL injection based on a big data algorithm provided by the present invention are set forth hereinafter:

Step S1: data of a target machine for simulating an SQL injection attack is collected, extracted information including IP address information, port information, a protocol category, a host domain name, an URI, a request manner, and traffic occurring time; and these information serves as negative sample data to store to a hdfs of a Hadoop.

Step S2: a main characteristic in an URI of SQL injection attack data, that is, a sentence having an SQL grammar really, is extracted based on characteristic engineering, the URI is escaped into a segment of readable text based on a rule of a URL character, and word segmentation is performed on the attack data according to a space, wherein a segmented word must carry the URL character, for example, with the word segmentation, SELECT * FROM TABLE is SELECT % 20, % 2A % 20, FROM % 20 and TABLE.

Step S3: normal data of an actual production environment is collected, extracted information including IP address information, port information, a protocol category, a host domain name, an URI, a request manner, and traffic occurring time; and these data serves as a positive sample to store to the hdfs of the Hadoop.

Step 4: the word segmentation is performed on the positive sample, a URI in an access link is segmented into a single term with “/”, “?”, “=” and the like, the word segmentation is performed on normal data according to the space, and a segmented word is escaped, for example, with the word segmentation, /HOME/CATEGORY is % 2F, HOME, % 2F and CATEGORY

Step S5: the positive sample and the negative sample are mixed according to a proportion of 1:1, and each word in the mixed sample is endowed with a weight by using a Term Frequency (TF)-Inverse Document Frequency (IDF) algorithm to obtain a TF vector of each word and a weight vector that indicates an importance of each word in the sample.

Step S6: in order to verify whether the mixed sample is reliable, the mixed sample is divided into a training set and a check set according to a proportion of 7:3, and a naive Bayes classification model is obtained via the training set; and the check set is classified by using the obtained naive Bayes classification model, an accuracy and a confusion matrix are obtained according to a comparison between a detected value and a data label and a parameter is adjusted by the accuracy and the confusion matrix, so that a classification result is more excellent.

Step S7: a MODEL generated by the naive Bayes classification model is put into an actual environment for operation and learning; when the SQL injection attack is detected, an expert may make a further confirmation on a result; and when confirmed to be the SQL injection attack or a new SQL injection manner, the result may be labeled and added to the training set to enrich a training sample, so that the model is more and more accurate and the classification result is more excellent.

The technical solutions of the present invention have the following beneficial effects:

1. Compared with former detection on SQL injection, the present invention combines a term after word segmentation with a URL escape character from a new perspective, thus discovering whether a device is attacked in time.

2. With the adoption of a supervised machine learning manner, and by using a naive Bayes algorithm to identify the SQL injection, an SQL injection attack and an attack source can be discovered timely and accurately, and a problem can be solved from the source.

3. According to an SQL injection manner, a user can discover whether a device backend has a loophole timely and optimize the device backend for an injected place, to improve the security.

### BRIEF DESCRIPTION OF THE DRAWINGS

In order to describe the technical solutions in the embodiments of the present invention or in the conventional art more clearly, a simple introduction on the accompanying drawings which are needed in the description of the embodiments or conventional art is given below. Apparently, the accompanying drawings in the description below are merely some of the embodiments of the present invention, based on which other drawings may be obtained by those of ordinary skill in the art without any creative effort.

The sole FIGURE is a flowchart of the present invention.

### DETAILED DESCRIPTION OF THE EMBODIMENTS

The present invention is further described below in detail in combination with the accompanying drawings. The described detailed embodiments are merely one part of the present invention, rather than a limit for the present invention.

Step S1: data of a target machine for simulating an SQL injection attack is collected, extracted information including IP address information, port information, a protocol category, a host domain name, an URI, a request manner, and traffic occurring time; and these information serves as negative sample data to store to a hdfs of a Hadoop.

Step S2: a main characteristic in an URI of SQL injection attack data, that is, a sentence having an SQL grammar really, is extracted based on characteristic engineering, the URI is escaped into a segment of readable text based on a rule of a URL character, the rule including the following fields:

| ASCII character | URL code |
|---|---|
| Space | %20 |
| ! | %21 |
| \ | %22 |
| # | %23 |
| $ | %24 |
| & | %26 |
| ′ | %27 |
| ( | %28 |
| ) | %29 |
| * | %2A |
| + | %2B |
| , | %2C |
| : | %3A |
| ; | %3B |
| < | %3C |
| = | %3D |
| > | %3E |
| ? | %3F |
| @ | 40% |
| \ | %5C |
| \| | %7C |
| } | %7D |
| { | %7B |

and word segmentation is performed on the attack data according to a space, wherein a segmented word must carry the URL character, for example, with the word segmentation, SELECT * FROM TABLE is SELECT % 20, % 2A % 20, FROM % 20 and TABLE.

Step S3: normal data of an actual production environment is collected, extracted information including IP address information, port information, a protocol category, a host domain name, an URI, a request manner, and traffic occurring time; and these data serves as a positive sample to store to the hdfs of the Hadoop.

Step S4: the word segmentation is performed on the positive sample, a URI in an access link is segmented into a single term with “/”, “?”, “=” and the like, the word segmentation is performed on normal data according to the space, and a segmented word is escaped according to the above table, for example, with the word segmentation, /HOME/CATEGORY is % 2F, HOME, % 2F and CATEGORY

Step S5: the positive sample and the negative sample are mixed according to a proportion of 1:1, and each word in the mixed sample is endowed with a weight by using a TF-IDF algorithm. In a given sample, the TF (Term Frequency) refers to a frequency that a given term occurs in the sample. The figure is a normalization of a term count so as to prevent the term from deviating to a large sample. That is, the term count of a same term in the large sample is greater than that in a small sample, no matter whether the term is important. Supposing that the sample dⱼ has k words tᵢ, and the number of times that each word occurs in the sample dⱼ is nᵢⱼ, the TF of each word is:

$${tf}_{ij} = \frac{{n}_{ij}}{{\sum }_{k} {n}_{kj}}$$

A TF vector is (tf₁ⱼ, tf₂ⱼ, . . . , tfᵢⱼ).

The IDF (Inverse Document Frequency) is a metric for universal importance of the term. The IDF of some special term may be obtained by dividing the number of documents including the term from a total number of documents, and then taking a logarithm of an obtained quotient:

$${idf}_{i} = log \frac{\vert D \vert}{\vert \{ j \text{:} {t}_{i} ∈ {d}_{j} \} \vert}$$

However, it is possible that the term is not present in a language database, so that a denominator of the above formula is 0. In order to prevent such a case, the denominator is added with 1.

$${idf}_{i} = log \frac{\vert D \vert}{\vert \{ j \text{:} {t}_{i} ∈ {d}_{j} \} \vert + 1}$$

Thus, an importance weight vector of each word of the term tᵢ between statements is:

tfᵢidfᵢ=tfᵢ×idfᵢ

Step 6: Bayes classification is a very simple classification algorithm; an ideological basis of the naive Bayes is to solve, for a given to-be-classified item, a probability of each category in a case where this item occurs. The to-be-classified item pertains to the category with the largest probability.

In order to verify whether the mixed sample is reliable, the mixed sample is divided into a training set and a check set according to a proportion of 7:3, the training set is set as C={y₁, y₂, . . . , yₙ}, the check set is set as X={x₁, x₂, . . . , xᵢ}, a characteristic vector of each to-be-checked item is x={α₁, α₂, . . . , αₘ}, whether the to-be-checked item x₁={α₁, α₂, . . . , αₘ} pertains to some category xᵢ ∈ yₖ in the training set is calculated, and the probability is:

P(yₖ|xᵢ)=max {P(y₁|xᵢ), P(y₂|xᵢ), . . . , P(yₙ|xᵢ)}

In order to calculate P(yₖ|xᵢ) , the probability between each attribute of the to-be-checked item xᵢ={α₁, α₂, . . . , αₘ} and a condition of some category in the training set is estimated as:

P(yₖ|α₁), P(y₂|α₂), . . . , P(yₙ|αₘ)

As each word is individual to each other, and the characteristic vector of the word is also individual to each other, it is deviated according to a Bayes probability that:

$$P ( {y}_{k} \vert {x}_{i} ) = \frac{P ( {x}_{i} \vert {y}_{i} ) P ( {y}_{i} )}{p ( {x}_{i} )}$$

Since the denominator is a constant for all categories, only a member needs to be maximized. Moreover, since each characteristic attribute is individual in condition, the following is obtained:

$$P ( {x}_{i} \vert {y}_{i} ) P ( {y}_{i} ) = P ( {y}_{k} \vert {α}_{1} ) P ( {y}_{2} \vert {α}_{2} ) … P ( {y}_{n} \vert {α}_{m} ) = P ( {y}_{k} ) {\prod }_{j = 1}^{m} P ( {α}_{j} \vert {y}_{k} )$$

In this way, the probability that the word in each check set pertains to some word category in the training set may be calculated. As the category to which the word pertains is known via the check set as a matter of fact, a confusion matrix is performed on a predicted category and an original category in the check set, with a structure as follows:

| | Positive | Negative |
|---|---|---|
| Positive | The actual category is | The actual category is |
| | Positive; and the predicted | Negative; and the predicted |
| | category is the number of | category is the number of |
| | samples in Positive, which is | samples in Positive, which is |
| | also referred to true | also referred to false |
| | positive (TP) | positive (FP) |
| Negative | The actual category is | The actual category is |
| | Positive; and the predicted | Negative; and the predicted |
| | category is the number of | category is the number of |
| | samples in Negative, which is | samples in Negative, which is |
| | also referred to false | also referred to true |
| | negative (FN) | negative (TN) |

An accuracy of a classifier is calculated according to the confusion matrix. Supposing that the number of samples is N, N=TP+FP+FN+TN, and the accuracy is:

$$accuracy = \frac{( TP + TN )}{N}$$

At last, a parameter is adjusted by using the accuracy and the confusion matrix, so that a classification result is more excellent.

Step S7: a MODEL generated by the naive Bayes classification model is put into an actual environment for operation and learning; when the SQL injection attack is detected, an expert may make a further confirmation on a result; and when confirmed to be the SQL injection attack or a new SQL injection manner, the result may be labeled and added to the training set to enrich a training sample, so that the model is more and more accurate and the classification result is more excellent.

The above gives a detailed introduction to the method for detecting the SQL injection based on the big data algorithm provided in the embodiments of the present invention. In the specification, a specific example is used to describe a principle and an implementation manner of the present invention. The description on the above embodiments is merely helpful to understand a method and a core concept of the present invention. Meanwhile, those of ordinary skill in the art may make a change within a scope of the specific implementation manners and applications according to a concept of the present invention. To sum up, the content in the specification should not be understood as a limit to the present invention.

What is claimed is:

1. A method for detecting Structured Query Language (SQL) injection based on a big data algorithm, wherein the method combines a term after word segmentation with a Uniform Resource Locator (URL) escape character, uses a supervised machine learning manner and uses a Bayes naive algorithm to identify the SQL injection, and timely discovers whether a device backend has a loophole according to an SQL injection manner, thus optimizing the device backend for an injected place and improving the security.

2. The method for detecting SQL injection based on the big data algorithm as claimed in claim 1, wherein a method for processing a characteristic based on an URL character semantic transformation uses the URL character semantic transformation to process the characteristic, so that a word and a sentence in an URL are segmented and the URL escape character is further carried; and thus, a training set meeting a URL specification is constructed, and a false alarm rate and an alarm leakage rate of the algorithm for the SQL injection are reduced.

3. The method for detecting SQL injection based on the big data algorithm as claimed in claim 1, wherein concerning a method for enhancing the training set based on an expert determination, a result identified by the algorithm is further processed and artificially confirmed by an expert, and then can be struck into the training set again, so that the training set is continuously expanded to improve an identification accuracy of the algorithm for the SQL injection.
